(19) United States
(12) Patent Application Publication
(10) Pub. No.: US 2016/0239914 A1
(43) Pub. Date: Aug. 18, 2016

(54) Analyzing Financial Market Transactions

(71) Applicant: Bank of America Corporation, Charlotte, NC (US)

(72) Inventor: Eoin O'Meara, London (GB)

(21) Appl. No.: 14/624,650

(22) Filed: Feb. 18, 2015

(51) Int. Cl. G06Q 40/04

(52) U.S. Cl. CPC G06Q 40/04

(57) ABSTRACT

In one embodiment, a system for analyzing variance in financial transactions includes an interface operable to receive an electronic message that indicates a plurality of financial trades. A processor communicatively coupled to the interface and operable to determine whether the plurality of financial trades occurred during a pre-determined trade period. The processor may also be operable to categorize each of the plurality of financial trades made during the pre-determined trade period as a selected one of acceptable and unacceptable according to a plurality of trade categories. The processor may then associate a client identifier with each of the plurality of financial trades and create a client-trade portfolio by consolidating the plurality of financial trades having a same client identifier. The process may then calculate a risk-factor percentage associated with the client-trade portfolio.

### TECHNICAL FIELD

This disclosure relates generally to financial market transactions and, more specifically, to analyzing financial market transactions.

### BACKGROUND

Each day, thousands of trades occur on markets around the world. Enterprises investing and managing trade portfolios must keep track of each trade, monitor the variances between transactions, and evaluate new and matured trades. Depending on the performance of each trade and other market movements such as maturities, an enterprise may need to adjust the collateral held on behalf of a client. Enterprises spend significant resources monitoring trades and making collateral decisions.

### SUMMARY OF THE DISCLOSURE

In accordance with the present disclosure, disadvantages and problems associated with analyzing financial market transactions may be reduced or eliminated.

In one embodiment, a system for analyzing variance in financial transactions includes an interface operable to receive an electronic message that indicates a plurality of financial trades. A processor, communicatively coupled to the interface, is operable to determine whether the plurality of financial trades occurred during a pre-determined trade period. The processor may also be operable to categorize each of the plurality of financial trades as a selected one of acceptable and unacceptable according to a plurality of trade categories. The processor may then associate a client identifier with each of the plurality of financial trades and create a client-trade portfolio by consolidating the plurality of financial trades having a same client identifier. The processor may then calculate a risk-factor percentage associated with the client-trade portfolio.

In another embodiment, a method for analyzing variance in financial transactions includes receiving, at an interface, an electronic message that indicates a plurality of financial trades. The method then determines, with a processor, whether the plurality of financial trades occurred during the previous two business days. The method may then categorize each of the plurality of financial trades as a selected one of acceptable and unacceptable according to a plurality of trade categories. Each of the plurality of financial trades may then be associated with a client identifier. The plurality of trades having the same client identifier may be consolidated to create a client-trade portfolio. The method may then calculate a risk-factor percentage associated with the client-trade portfolio.

Certain embodiments of the present disclosure may provide one or more technical advantages. One advantage of the present disclosure allows for a more efficient and less time-consuming identification of inaccurate or troublesome trade evaluations. Another advantage allows for a more accurate calculation of a margin call sent to a client. In still another embodiment, the risks associated with improperly understanding credit exposure, liquidity, and market risk are reduced. One or more other technical advantages may be readily apparent to one skilled in the art from the figures, descriptions, and claims, included herein.

### BRIEF DESCRIPTION OF THE DRAWINGS

For a more complete understanding of the present disclosure and for further features and advantages thereof, reference is now made to the following description taken in conjunction with the accompanying drawings, in which:

FIG. 1 illustrates an example system for analyzing variance in financial transactions;

FIG. 2 is a screenshot illustrating an embodiment of a financial transaction analysis application;

FIG. 3A is a screenshot illustrating an embodiment of financial transaction analysis application displaying a list of trade categories;

FIG. 3B is a screenshot illustrating an embodiment of a financial transaction analysis application displaying a list of trades that have been categorized; and

FIG. 4 is a flowchart of a method for analyzing variance in financial transactions.

### DETAILED DESCRIPTION

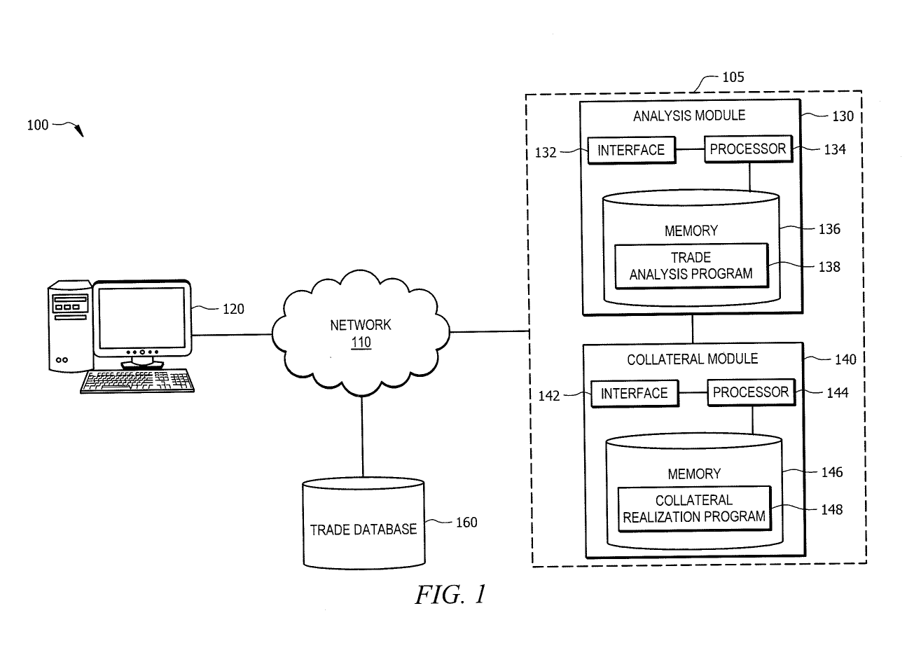

Embodiments of the present disclosure and its advantages are best understood by referring to FIGS. 1-4, like numerals being used for like and corresponding parts of the various drawings.

Each day, thousands of trades occur on markets around the world. Enterprises investing and managing trade portfolios must keep track of each trade, monitor the variances between transactions, and evaluate new and matured trades. Depending on the performance of each trade, an enterprise may need to adjust the collateral held on behalf of a client. Enterprises spend significant resources monitoring trades and making collateral decisions.

For example, in certain embodiments enterprises may want to analyze the mark to market variance of a trade occurring over a certain trading period. Generally, mark to market analysis addresses the measure of the fair value of trades and accounts that change over time. To properly evaluate their holdings, enterprises may need to accurately appraise the value of a trade (i.e., a security, portfolio, or other asset) to reflect its current market value instead of its value as reflected on the books of one enterprise.

It is advantageous to provide a system and method that analyzes variance in financial transactions. For example, an analysis module may receive an electronic message that indicates a plurality of financial trades. The analysis module may then determine whether the plurality of financial trades occurred during a pre-determined trade period. For example, the analysis module may look at financial trades made over the previous two business days. The analysis module may then categorize each of the plurality of financial trades made during the pre-determined trade period as a selected one of acceptable and unacceptable according to a plurality of trade categories. Once categorized, the analysis module may then associate a client identifier with each of the plurality of financial trades and create a client-trade portfolio by consolidating the plurality of financial trades having a same client identifier. Once the client-trade portfolio is created, a collateral module may calculate a risk-factor percentage associated with the client-trade portfolio.

The risk-factor percentage of a client-trade portfolio may be calculated as the percentage of financial trade variance in the client-trade portfolio attributable to trades categorized as acceptable. In certain embodiments, if the risk-factor is less than a pre-determined percentage (e.g., 95%, 90%, or 85%), the collateral module may identify the client-trade portfolio and indicate that the portfolio needs further investigation by a financial associate. The collateral module may also determine whether the client is over or under-collateralized based on the client-trade portfolio and a client service agreement. If the client is under-collateralized, the collateral module may generate and communicate to the client a margin call indicating the amount that the client is under-collateralized. In general, a margin call is issued when the equity a client has in an account falls below a certain level. The level may be set by regulation, or an enterprise may establish a higher cutoff. A margin call may require the client to deposit additional collateral with the enterprise or the enterprise may liquidate client assets to bring the client's equity up to the required level. If the client is instead over collateralized, the collateral module may transfer collateral to the client.

FIG. 1 illustrates an example system 100 for analyzing variance in financial transactions. System 100 includes an enterprise 105 comprising an analysis module 130 and a collateral module 140. System 100 also includes a workstation 120 and a trading database 160. Workstation 120, analysis module 130, collateral module 140 and trading database 160 may communicate through network 110.

Network 110 represents any suitable network operable to facilitate communication between the components of system 100. Network 110 may include any interconnecting system capable of transmitting audio, video, signals, data, messages, or any combination of the preceding. Network 110 may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof operable to facilitate communication between the components.

Enterprise 105 represents an individual, business, company, or other organization. An example of an enterprise may include a financial institution. In the illustrated embodiment, enterprise 105 comprises analysis module 130 and collateral module 140. Enterprise 105 may facilitate communicating information between analysis module 130 and collateral module 140. Further, enterprise 105 may communicate information between workstation 120, analysis module 130, collateral module 140, and trade database 160. Even though enterprise 105 is referred to as a financial institution, enterprise 105 may include any suitable type of entity in any suitable industry.

Workstation 120 enables one or more users to monitor, administer, or otherwise interact with analysis module 130, collateral module 140, and trading database 160. Workstation 120 may include one or more laptops, personal computers, monitors, display devices, handheld devices, smartphones, servers, user input devices, or other suitable components for enabling user input. Workstation 120 may itself include analysis module 130, collateral module 140, and trading database 160. Workstation 120 may be a part of enterprise 105 or could remotely access enterprise 105.

In certain embodiments, workstation 120 may communicate with analysis module 130 and collateral module 140 to facilitate analyzing variance in financial transactions. Workstation 120 may access a client-trade portfolio and identify the specific trades in the portfolio that have been categorized as either acceptable or unacceptable. For example, a trade may be marked as unacceptable because the trade was dropped without explanation. Workstation 120 may conduct further investigation into the dropped trade by communicating with trade database 160 to collect additional information regarding the background and history of the trade. In another example, a trade may be marked as unacceptable if the trade exceeds the trade threshold for the particular client. The trade threshold may be violated if the trade variance of a specific trade, relative to the trade's size, varies more than a certain percentage (e.g., 5%, 7.5%, 10%). Workstation 120 may investigate any trades having a variance that exceeds this threshold. In certain embodiments, if, after further investigation, the trade is deemed acceptable, workstation 120 may adjust the status of the trade in the client-trade portfolio from unacceptable to acceptable. In other embodiments, workstation 120 may be used to add new trade categories to trade analysis program 138 or refine the trade categories already being implemented by analysis module 130.

Analysis module 130 and collateral module 140 represent any suitable components that facilitate analyzing variance in financial transactions. Analysis module 130 and collateral module 140 may also be any suitable components that generate and facilitate the transfer of collateral between enterprise 105 and a client. Analysis module 130 and collateral module 140 may include a network server, remote server, mainframe, host computer, workstation, web server, personal computer, file server, or any other suitable device operable to communicate with other devices and process data. In some embodiments, analysis module 130 and collateral module 140 may execute any suitable operating system such as IBM's zSeries/Operating System (z/OS), MS-DOS, PC-DOS, MAC-OS, WINDOWS, UNIX, OpenVMS, Linux, or any other appropriate operating systems, including future operating systems.

The functions of analysis module 130 and collateral module 140 may be performed by any suitable combination of one or more servers or other components at one or more locations. In the embodiment where the modules are servers, the servers may be public or private servers, and each server may be a virtual or physical server. The server may include one or more servers at the same or at remote locations. Analysis module 130 and collateral module 140 may also include any suitable component that functions as a server. In some embodiments, workstation 120 and trading database 160 may be integrated with analysis module 130 and collateral module 140 or they may operate as part of the same device or devices.

In the illustrated embodiment, analysis module 130 includes an interface 132, a processor 134, and a memory 136, which comprises trade analysis program 138. Collateral module 140 includes an interface 142, a processor 144, and a memory 146, which comprises collateral realization program 148.

Analysis module interface 132 and collateral module interface 142 represent any suitable device operable to receive information from network 110, transmit information through network 110, perform suitable processing of the information, communicate to other devices, or any combination thereof. Analysis module interface 132 and collateral module interface 142 represent any port or connection, real or virtual, including any suitable hardware and/or software, including protocol conversion and data processing capabilities, to communicate through a LAN, WAN, or other communication system that allows analysis module 130 and collateral module 140 to exchange information with network 110, workstation 120, trading database 160, or any other components of system 100.

Analysis module interface 132 may be used to identify and receive a plurality of trades made during a pre-determined trade period. For example, analysis module interface 132 may communicate with trade database 160 to identify all the trades associated with a client-trade portfolio and their performances over the past two business days. Analysis module 130 may utilize interface 132 to extract data regarding each trade from trade database 160. Data may include information such as a close of business date, a trade variance of the trade during the trading period, a market location, whether the trade is new, matured, has migrated, or was terminated. Analysis module interface 132 may also communicate with collateral module 140 through collateral module interface 142. For example, analysis module interface 132 may transfer information regarding client-trade portfolios, trades that have been marked as acceptable and unacceptable, identified market risks to collateral module 140 via interface 142, and/or perform any other suitable action.

Collateral module interface 142 may communicate risk-factor percentages associated with client-trade portfolios, send alerts to workstation 120 when trades have breached threshold values, generate margin calls to clients when the client becomes under-collateralized, and/or any other suitable actions. For example, collateral module 140 may receive, via interface 142, a client-trade portfolio identifying a plurality of trades associated with the client, and an indication whether those trades are acceptable or unacceptable. As another example, collateral module interface 142 may indicate that the risk-factor percentage of a client-trade portfolio is below a desired percentage, e.g., 90%.

Analysis module processor 134 communicatively couples interface 132 and memory 136 and controls the operation of analysis module 130. Similarly, collateral module processor 144 communicatively couples interface 142 and memory 146 and controls the operation of collateral module 140. Analysis module processor 134 and collateral module processor 144 include any hardware and software that operates to control and process information.

In one embodiment, analysis module processor 134 categorizes the trades identified by interface 132 as either acceptable or unacceptable based on a plurality of trade categories. Trade analysis program 138 may include a number of trade categories including but not limited to an acceptable category for new trades, an acceptable category for matured trades, an unacceptable category for trades having a gross variance greater than a predetermined value, an unacceptable category for trades having a notional variance greater than a predetermined threshold, and an unacceptable category for client-trade portfolios having a total variance greater than a predetermined value. As a specific example, processor 134 may identify a trade's variance over the course of two business days. Processor 134 may identify whether the variance of the specific trade is within a pre-determined threshold allowed for that trade, such as 7.5%. If the trade has a variance of $7 mm and the trade is valued at $200 mm, then the notional variance of the trade is at 3.5%, which is within the allowed threshold. Similarly, processor 134 may determine whether an individual trade has a gross variance greater than a set limit, such as $100 mm. If a single trade mark to market variance is $110 mm, regardless of the trade's total value, then processor 134 may categorize the trade as unacceptable. Processor 134 may apply any number of trade categories stored in trade analysis program 138 such as determining whether a trade is a new trade, a matured trade, or a cash settlement. Analysis module processor 134 may also generate updates to the trades categorized as acceptable or unacceptable and store in memory 136 the trade category associated with each trade.

Analysis module processor 134 may also associate a client identifier with each of the plurality of trades. In certain embodiments, the client identifier may include additional information including the client's name and institutional information and the client's service agreement. A client service agreement may include information such as a minimum margin call that the enterprise will send in response to trade variances in the client-trade portfolio. The client service agreement may also include information such as client-specific threshold values to indicate relative trade variance for specific trades. For example, enterprise 105 may apply a default threshold value of 7.5% when categorizing trades, and may categorize trades less than the threshold value as acceptable. The client service agreement may establish a threshold value that supersedes the threshold established by enterprise 105. For example, the client service agreement may apply a threshold value of 5% to trades in the related client-trade portfolio. Once a client identifier is associated with each trade, analysis module processor 134 may create a client-trade portfolio by grouping together each of the plurality of trades having the same client identifier. In this manner, each client-trade portfolio may have a plurality of trades categorized by analysis module processor 134 as either acceptable or unacceptable.

In the illustrated embodiment, collateral module processor 144 may calculate a risk-factor percentage associated with each client-trade portfolio. Collateral module interface 142 may receive a plurality of client-trade portfolios comprising a number of trades that have been categorized as either acceptable or unacceptable from analysis module 130. Collateral module processor 144 may then calculate a risk-factor percentage of the client-trade portfolio. In certain embodiments, the risk-factor percentage is the percentage of trade variance within a client-trade portfolio attributable to trades categorized as acceptable. In certain embodiments, if the risk-factor percentage is less than a pre-determined percentage (e.g., 95%, 90%, or 85%), collateral module 140 may indicate that the portfolio needs further investigation. For example, if a client-trade portfolio has $100 mm in total trade variance, and $96 mm of the $100 mm is part of trades categorized as acceptable, then the risk-factor percentage may be 96%. If enterprise 105 has a risk-factor percentage cutoff at 95% then the client-trade portfolio may be highlighted to indicate that the portfolio is in good standing, for example, by highlighting the portfolio in green in collateral module 140. If, instead enterprise 105 has a risk-factor percentage cutoff at 98%, then the client-trade portfolio may be highlighted to indicate that further investigation of the portfolio is required, for example, by highlighting the portfolio in red in collateral module 140.

Collateral module processor 144 may also determine whether the client is over or under-collateralized based on the client-trade portfolio and a client service agreement. If the client is under-collateralized, collateral module 140 may communicate a margin call to the client. If the client is over-collateralized, collateral module 140 may facilitate a transfer of collateral to the client. Collateral module 140 may communicate with another module in enterprise 105 to generate a transfer of collateral to the client. The client's service level agreement may specify the minimum level of a margin call that may be initiated by collateral module 140. In certain embodiments, collateral module processor 144 may first determine whether the risk-factor percentage is above a pre-determined amount before determining whether the client is over or under collateralized. For example, if enterprise 105 has a risk-factor percentage cutoff at 95% and the risk-factor percentage is 98% then collateral module will then determine if the client is over or under collateralized. If the risk-factor percentage is less than the cutoff, then the client-trade portfolio may first need to be investigated before any collateral decisions are made.

Analysis module memory 136 and collateral module memory 146 store, either permanently or temporarily, data, operational software, other information for processor 134 and processor 144, respectively, or other components of system 100. Analysis module memory 136 and collateral module memory 146 include any one or a combination of volatile or nonvolatile local or remote devices suitable for storing information. For example, analysis module memory 136 and collateral module memory 146 may include RAM, ROM, flash memory, magnetic storage devices, optical storage devices, network storage devices, cloud storage devices, solid state devices, or any other suitable information storage device or a combination of these devices. Analysis module memory 136 and collateral module memory 146 may store information in one or more databases, file systems, tree structures, any other suitable storage system, or any combination thereof. Furthermore, different information stored in analysis module memory 136 and collateral module memory 146 may use any of these storage systems (e.g., trade analysis program 138 and collateral realization program 148 may be stored in a relational database). Moreover, any information stored in memory 136 may be encrypted or unencrypted, compressed or uncompressed, and static or editable. Although illustrated as including particular modules, memory 136 may include any suitable information for use in the operation of prediction module 130.

In the illustrated embodiment, analysis module memory 136 includes trade analysis program 138, while collateral module memory 146 includes collateral realization program 148.

Trade analysis program 138 represents any trading algorithm that can use information pertaining to trades made during a specific interval to categorize the trades as either acceptable or unacceptable based on a number of trade categories. Trade analysis program 138 may include information regarding the maturity dates for trades and/or origination and expiration dates for new trades or expiring trades. In another embodiment, trade analysis program 138 may include regulatory rules (e.g., Dodd-Frank Wall Street Reform and Consumer Protection Act of 2010, SEC regulations) that may help ensure that trades and client-trade portfolios are in compliance with various regulatory schemes.

Collateral realization program 148, represents any collateral calculating program that can calculate a risk-factor percentage associated with a client-trade portfolio and determine, based on a client service agreement and client-trade portfolio, whether the client is over or under-collateralized. Collateral realization program 148 may include information such as the minimum margin call collateral module 140 may send to a specific client. Collateral realization program 148 may also highlight market risk/liquidity as a result of inaccurate trade valuations.

Trade database 160 represents any database, system, or computer that is capable of providing information regarding trades, including over-the-counter (OTC) derivatives, exchange-traded derivatives (ETDs), forwards, futures, options, swaps, stock, bonds, or any other securities and contracts. Trade database 160 may include information from one or more markets including but not limited to New York, Tokyo, London, Dubai, Chicago, and Australia. Trade database 160 may also include information such as the close-of-business date of a specific trade, the trade's mark to market variance, and contract terms such as expiration and maturity dates.

A component of system 100 may include an interface, logic, memory, and other suitable elements. An interface receives input, sends output processes the input and/or output, and performs other suitable operations. An interface may comprise hardware and software. Logic performs the operation of the component. For example, logic executes instructions to generate output from input. Logic may include hardware, software and other logic. Logic may be encoded in one or more non-transitory, tangible media, such as a computer readable medium or any other suitable tangible medium, and may perform operations when executed by a computer. Certain logic, such as a processor, may manage the operation of a component. Examples of a processor include one or more computers, one or more microprocessors, one or more applications, and other logic.

Modifications, additions, or omissions may be made to system 100 without departing from the scope of the invention. In certain embodiments, analysis module 130 may include additional trade categories for categorizing a trade, such as categorizing the trade as unacceptable if the trade has a variance of zero for a given trading period. In other embodiments, analysis module 130 may calculate an anticipated variance for a given trade and categorize the trade as unacceptable if the actual variance differs from the anticipated variance by more than a pre-determined percent (e.g., 1%, 2%, 5%). In some embodiments, clients may have more than one client-trade portfolio. In certain embodiments, analysis module 130 and collateral module 140 may be integrated and trade analysis program 138 and collateral realization program 148 may be combined into a single program. Any suitable logic may perform the functions of system 100 and the components within system 100.

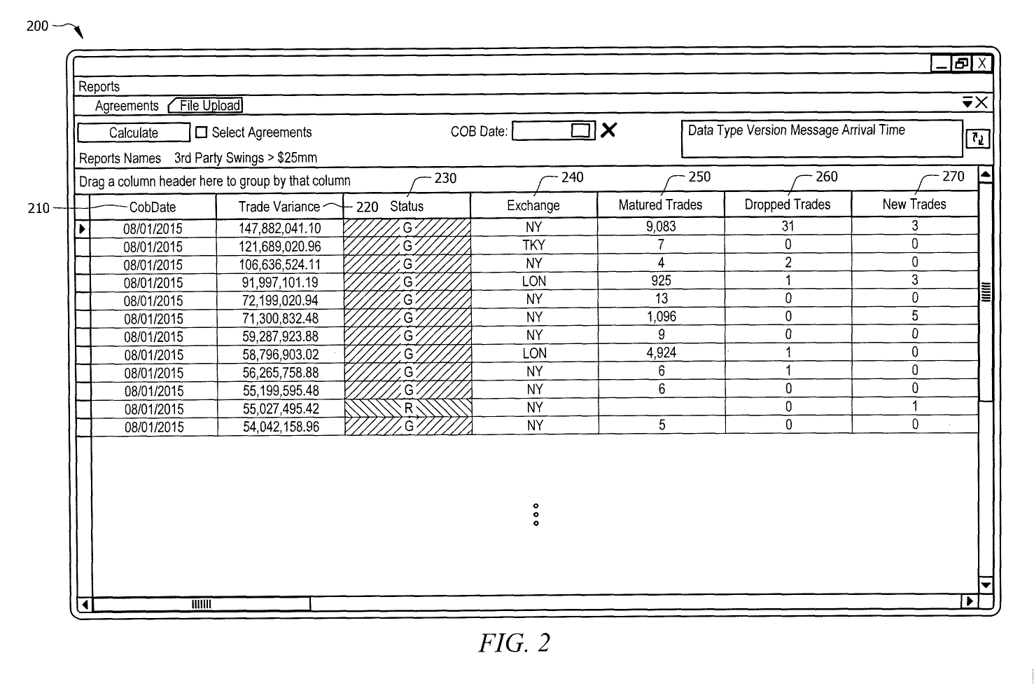

FIG. 2 is a screenshot illustrating an embodiment of a financial transaction analysis application 200. In an embodiment, analysis module 130 may communicate with trade database 160 to identify all the trade activity taking place over the last two business days. Analysis module 130 may pull data about each trade from trade database 160. Data may include information such as the close of business date, the variance of the trade during the trading period, the market location, whether the trade is new, matured, has migrated, or was terminated. Financial transaction analysis application 200 is an example of the information gathered by analysis module 130 and displayed to a user using workspace 120. Financial transaction analysis application 200 may also include each trade's client identifier and which client-trade portfolio the trade belongs.

Column 210 displays the Close-of-Business (CoB) date of a trade. This date may be used to determine the trade period. For example, analysis module 130 may analyze all trades with a specific date. Column 220 displays the trade variance of a trade. In certain embodiments, this may be a mark to market trade variance of an individual trade. Financial transaction analysis application may also include a trade variance column for the total trade variance of trades in a client-trade portfolio. Column 230 displays the status of each client-trade portfolio. In the illustrated embodiment, client-trade portfolios highlighted in a particular color may have a risk factor percentage above a pre-determined value. Client-trade portfolios highlighted in another particular color may have a risk-factor percentage lower than a pre-determined amount, indicating that a financial analyst should investigate the portfolio. Column 240 indicates the market where a trade is exchanged. For example, a trade may be exchanged on the New York Stock Exchange. By indicating which market a trade is exchanged, analysts may have a better idea of when trading will open and close for a given trade. Column 250 illustrates the number of matured trades in a client-trade portfolio. Financial transaction analysis application 200 may indicate how long a given trade remains outstanding. The maturity date indicated by column 250 may be important for trades involving fixed investments such as bonds. The maturity date may allow analysts to better predict and plan the time period enterprise 105 expects to hold a security. Column 260 indicates the number of dropped trades in a client-trade portfolio. Column 270 indicates the number of new trades made in a client-trade portfolio. Financial transaction analysis program 200 may include other trade categories depending on the variables that enterprise 105 deems relevant.

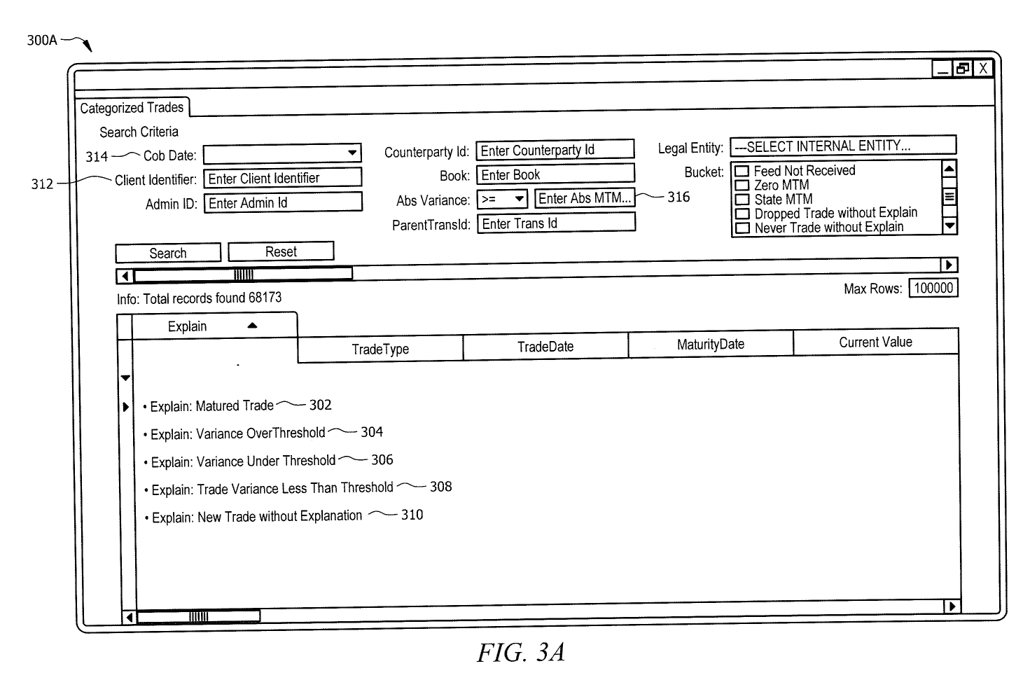

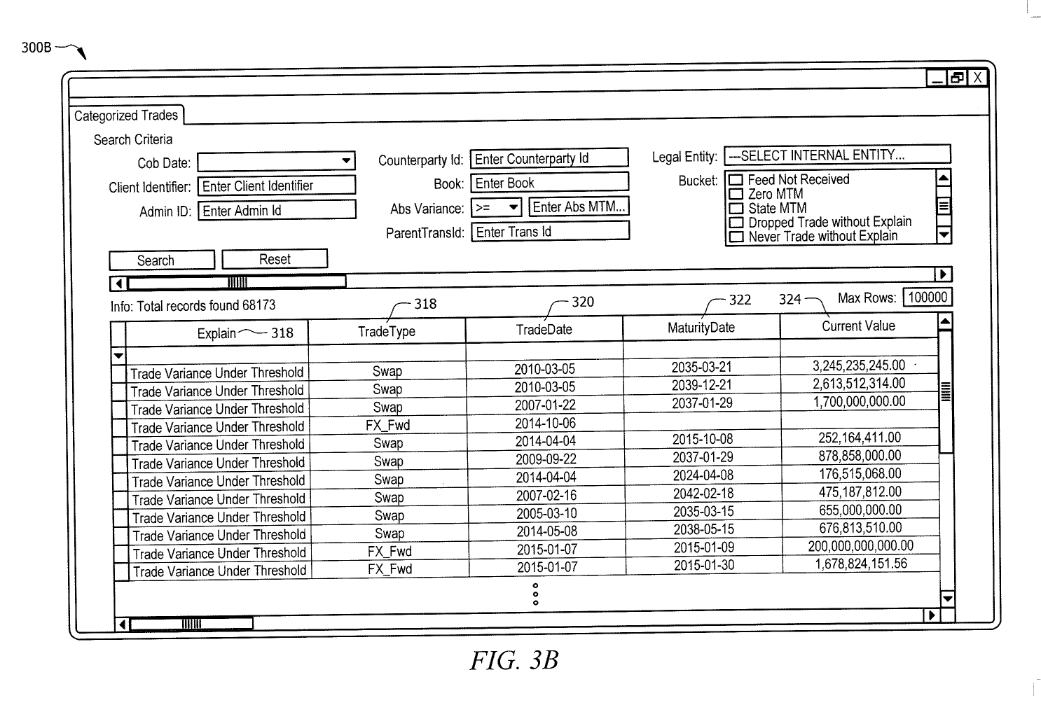

FIG. 3A is a screenshot illustrating an embodiment of financial transaction analysis application 200 displaying a list of trade categories. Categorized deals screen 300A allows workstation 120 to investigate the categorization of each trade or further investigate specific client-trade portfolios. When each trade is categorized as either acceptable or unacceptable, the trade may be further categorized by the trade category used to categorize the trade. The illustrated embodiment shows several trade categories including matured trades 302, trades with variance over threshold 304, trades with variance under threshold 306, notional trade variance less than pre-determined value 308, and new trades made without explanation 310. Workstation 120 may access categorized deals screen 300A to view all the trade categories that financial transaction analysis application 200 uses to categorize trades. Workstation 120 may access each trade category and view the trades categorized into that index.

In certain embodiments, categorized deals screen 300A allows workstation 120 to search for trades using other trade characteristics. For example workstation 120 may search by client-identifier tab 312, close-of-business date tab 314, or total trade variance tab 316. Accordingly, each trade and each client-trade portfolio may be investigated using a number of searching functions.

FIG. 3B is a screenshot illustrating an embodiment of financial transaction analysis application 200 displaying a list of trades that have been categorized. Screenshot 300B illustrates a list of trades categorized as trades with variance under threshold. Screenshot 300B may also include trade-specific information. For example, column 318 indicates the type of trade (e.g., swap, forward, option), column 320 shows the date the trade was made, column 322 shows the maturity date, and column 324 shows the current value of the trade. In this manner, workstation 120 may view each trade category used by financial transaction analysis application 200 and examine the specifics of each trade.

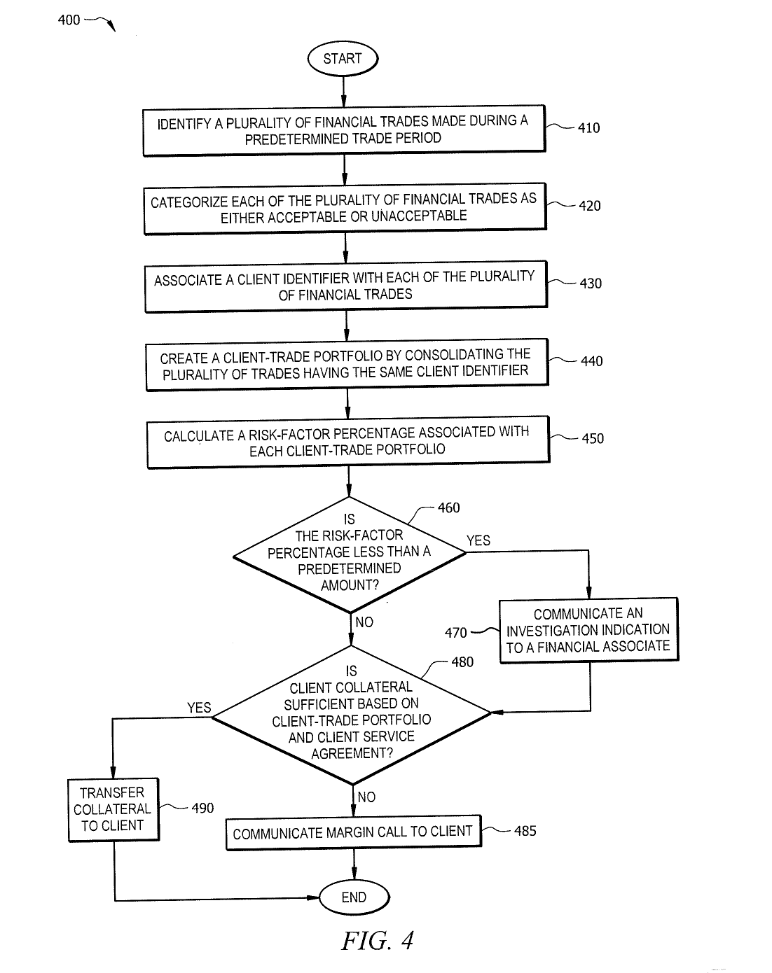

FIG. 4 is a flowchart of a method 400 for analyzing variance in financial transaction. At step 410, analysis module 130 identifies a plurality of trades made during a pre-determined trade window. For example, analysis module 130 may communicate with trade database 160 to identify all trade activity over that last two business days. Analysis module 130 may utilize interface 132 to extract data about each trade from trade database 160. Data may include information such as the close of business date, the mark to market variance of the trade during the trading period, the market location, whether the trade is new, matured, has migrated, or was terminated.

At step 420, analysis module 130 may categorize each of the trades as either acceptable or unacceptable according to a plurality of trade categories. For a given trade, analysis module 130 may determine the trade's variance over the course of the trade window. Analysis module 130 may determine whether the trade was dropped without explanation, whether the trade matured, was over or under the trade's allowed threshold, whether the trade had a stale or no variance, and whether the gross value of the trade exceeded certain limits. Analysis module 130 may then categorize each trade as acceptable or unacceptable and sub-categorize each trade into the index that made the trade qualify as acceptable or unacceptable.

At step 430, analysis module 130 may associate a client identifier with each of the identified and categorized trade. The client identifier may include additional information including the client's name and institutional information and the client's service agreement. A client service agreement may include information such as a minimum margin call that the enterprise will send in response to mark to market variances in the client-trade portfolio. The client service agreement may also include information such as client-specific threshold values to indicate relative mark to market variance for specific trades.

At step 440, analysis module 130 may create a client-trade portfolio by grouping together each of the trades having the same client identifier. Each client-trade portfolio may comprise a number of trades categorized as acceptable or unacceptable.

At step 450, collateral module 140 may calculate a risk-factor percentage associated with each client-trade portfolio. In certain embodiments, the risk-factor percentage is the percentage of mark to market trade variance within a client-trade portfolio attributable to trades categorized as acceptable. For example, if a client-trade portfolio has a total mark to market trade value of $100 mm and $90 mm of that value is from trades categorized as acceptable, then the risk-factor percentage may be 90%.

At step 460, collateral module 140 determines whether the risk-factor percentage is less than a pre-determined percentage (e.g., 95%, 90%, or 85%). If collateral module 140 determines that the risk-factor percentage is less than a pre-determined percentage, the sequence proceeds to step 470. If collateral module 140 determines that the risk-factor percentage is greater than or equal to the pre-determined percentage then the sequence proceeds to step 480.

At step 470, in response to the risk-factor percentage being less than a pre-determined percentage, collateral module 140 may highlight the client-trade portfolio, indicating that the portfolio needs further investigation. Workstation 120 may then be used to analyze the client-trade portfolio and look at the trades that have been categorized as unacceptable. Based on the further analysis, enterprise 105 may be able to make recommendations to the client based on the status of the client's trade portfolio.

At step 480, collateral module 140 may determine whether the client is over or under-collateralized based on the most recent financial market transaction analysis of the client-trade portfolio.

At step 485, in response to the client being under-collateralized, collateral module 140 sends a margin call to the client. In certain embodiments, collateral module 140 may first look at the client service agreement to determine if there is a minimum margin call value associated with the client. If the client is under-collateralized, but still under an amount indicated in the client service agreement, collateral module 140 may not send the margin call. At step 490, in response to the client being over collateralized, collateral module 140 may transfer collateral back to the client.

Various embodiments may perform some, all, or none of the steps described above. For example, in certain embodiments, analysis module 130 and collateral module 140 may be combined to perform each step of method 400 from a single module. Furthermore, certain embodiments may perform these steps in a different order or in parallel. Moreover, one or more steps may be repeated. Although discussed as analysis module 130 and collateral module 140 performing these steps, any suitable component of system 100 may perform one or more steps of the method.

Certain embodiments of the present disclosure may provide one or more technical advantages. One advantage of the present disclosure allows for a more efficient and less time-consuming identification of inaccurate or troublesome trade evaluations. Another advantage allows for a more accurate calculation of a margin call sent to a client. In still another embodiment, the risks associated with improperly understanding credit exposure, liquidity, and market risk are reduced. One or more other technical advantages may be readily apparent to one skilled in the art from the figures, descriptions, and claims, included herein.

Although the present disclosure has been described with several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims.

What is claimed is:

1. A system, comprising:
an interface operable to receive an electronic message that indicates a plurality of financial trades;
a processor communicatively coupled to the interface and operable to:
determine whether the plurality of financial trades occurred during a pre-determined trade period;
categorize each of the plurality of financial trades made during the pre-determined trade period as a selected one of acceptable and unacceptable according to a plurality of trade categories;
associate a client identifier with each of the plurality of financial trades;
create a client-trade portfolio by consolidating the plurality of financial trades having a same client identifier; and
calculate a risk-factor percentage associated with the client-trade portfolio.

2. The system of claim 1, wherein the client identifier comprises:
a client name; and
a client service agreement.

3. The system of claim 2, wherein the processor is further operable to:
determine that the risk-factor percentage is above a predetermined percentage;
determine whether collateral associated with the client-trade portfolio and the client service agreement is greater than a predetermined amount;
in response to the collateral being greater than a predetermined amount, transfer a portion of the collateral to the client; and
in response to the collateral being less than a predetermined amount, generate a margin call indicating an amount of the under collateralization to the client.

4. The system of claim 1, wherein the plurality of trade categories comprises:
an acceptable category for a new trade;
an acceptable category for a matured trade;
an unacceptable category for a trade having a gross variance greater than a predetermined value;
an unacceptable category for a trade having a notional variance greater than a predetermined threshold; and
an unacceptable category for a client-trade portfolio having a total variance greater than a predetermined value.

5. The system of claim 1, wherein the risk-factor percentage is based on a percentage of the total variance of the client-trade portfolio attributable to the variance of acceptable trades in the client-trade portfolio.

6. The system of claim 5, wherein the interface is further operable to:
in response to the risk-factor percentage being less than a predetermined percentage, automatically communicate an investigation indication to a financial associate.

7. The system of claim 1, wherein the pre-determined trade period occurs every two business days.

8. A non-transitory computer readable storage medium comprising logic, the logic operable, when executed by a processor, to:
receive an electronic message that indicates a plurality of financial trades;
determine whether the plurality of financial trades occurred during a pre-determined trade period;
categorize each of the plurality of financial trades made during the pre-determined trade period as a selected one of acceptable and unacceptable according to a plurality of trade categories;
associate a client identifier with each of the plurality of financial trades;
create a client-trade portfolio by consolidating the plurality of financial trades having a same client identifier; and
calculate a risk-factor percentage associated with the client-trade portfolio.

9. The non-transitory computer readable storage medium of claim 8, wherein the client identifier comprises:
a client name; and
a client service agreement.

10. The non-transitory computer readable storage medium of claim 9, wherein the logic is further operable, when executed by the processor, to:
determine that the risk-factor percentage is above a predetermined percentage;
determine whether collateral associated with the client-trade portfolio and the client service agreement is greater than a predetermined amount;
in response to the collateral being greater than a predetermined amount, transfer a portion of the collateral to the client; and
in response to the collateral being less than a predetermined amount, generate a margin call indicating an amount of the under collateralization to the client.

11. The non-transitory computer readable storage medium of claim 8, wherein the plurality of trade categories comprises:
an acceptable category for a new trade;
an acceptable category for a matured trade;
an unacceptable category for a trade having a gross variance greater than a predetermined value;
an unacceptable category for a trade having a notional variance greater than a predetermined threshold; and
an unacceptable category for a client-trade portfolio having a total variance greater than a predetermined value.

12. The non-transitory computer readable storage medium of claim 8, wherein the risk-factor percentage is based on a percentage of the total variance of the client-trade portfolio attributable to the variance of acceptable trades in the client-trade portfolio.

13. The non-transitory computer readable storage medium of claim 12, wherein the logic is further operable, when executed by the processor, to:
in response to the risk-factor percentage being less than a predetermined percentage, automatically communicate an investigation indication to a financial associate.

14. The non-transitory computer readable storage medium of claim 8, wherein the pre-determined trade period occurs every two business days.

15. A method, comprising:
receiving, at an interface, an electronic message that indicates a plurality of financial trades;
determining, with a processor, whether the plurality of financial trades occurred during the previous two business days;
categorizing, with the processor, each of the plurality of financial trades made during the previous two business days as a selected one of acceptable and unacceptable according to a plurality of trade categories;
associating, with the processor, a client identifier with each of the plurality of financial trades;
creating, with the processor, a client-trade portfolio by consolidating the plurality of financial trades having a same client identifier; and
calculating, with the processor, a risk-factor percentage associated with the client-trade portfolio.

16. The method of claim 15, wherein the client identifier comprises:
a client name; and
a client service agreement.

17. The method of claim 16, further comprising:
determining, by the processor, that the risk-factor percentage is above a predetermined percentage;
determining, by the processor, whether collateral associated with the client-trade portfolio and the client service agreement is greater than a predetermined amount;
in response to the collateral being greater than a predetermined amount, transferring a portion of the collateral to the client; and
in response to the collateral being less than a predetermined amount, generating a margin call indicating an amount of the under collateralization to the client.

18. The method of claim 15, wherein the plurality of trade categories comprises:
an acceptable category for a new trade;
an acceptable category for a matured trade;
an unacceptable category for a trade having a gross variance greater than a first predetermined value;
an unacceptable category for a trade having a notional variance greater than a predetermined threshold; and
an unacceptable category for a client-trade portfolio having a total variance greater than a second predetermined value.

19. The method of claim 15, wherein the risk-factor percentage is based on a percentage of the total variance of the client-trade portfolio attributable to the variance of acceptable trades in the client-trade portfolio.

20. The method of claim 19, further comprising:
in response to the risk-factor percentage being less than a predetermined percentage, automatically communicating an investigation indication to a financial associate.
